(19) United States
(12) Patent Application Publication
(10) Pub. No.: US 2010/0185368 A1
(43) Pub. Date: Jul. 22, 2010

(54) METHOD AND DEVICE FOR CONTROLLING A COASTING MOVEMENT OF A VEHICLE

(75) Inventors: Florian Schneider, Lindenberg (DE); Thomas Jager, Meckenbeuren (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/664,555

(22) PCT Filed: May 27, 2008
(86) PCT No.: PCT/EP2008/056450

§ 371 Date: Dec. 14, 2009

(30) Foreign Application Priority Data
Jun. 30, 2007 (DE) 10 2007 030 489.9

(51) Int. Cl. G06F 19/00; B60W 10/04; B60W 30/18

(52) U.S. Cl. 701/53; 477/73

(57) ABSTRACT

From a point when the clutch is disengaged, a braking torque is applied in addition to the braking torque of the drivetrain located downstream from the clutch. The braking torque of the drivetrain downstream from the clutch comprises, for example, a drag torques of the transmission, an axle and/or one or more brakes. The added braking torque applied corresponds to the braking torque of the internal combustion engine at, or immediately before, the instant when the internal combustion engine is decoupled from the drivetrain downstream from the clutch by disengaging the clutch. By applying the additional braking torque to the drivetrain downstream from the clutch, the total braking torque that acts on the wheel, before and after the disengagement of the clutch, remains the same. The vehicle can therefore coast or stop in a smooth manner.

This application is a National Stage completion of PCT/EP2008/056450 filed May 27, 2008, which claims priority from German patent application serial no. 10 2007 030 489.9 filed Jun. 30, 2007.

### FIELD OF THE INVENTION

The present invention concerns a device and a method for controlling a drivetrain.

### BACKGROUND OF THE INVENTION

In DE 198 07 095 a method is proposed for controlled braking during an automatic shift in a motor vehicle in thrust operation while moving down a steep slope, to prevent overspeeding of the engine when a low gear is engaged. The danger of stalling because of too low a speed of the internal combustion engine is not mentioned.

When a vehicle pulls up and coasts, the speed of its internal combustion engine falls. At a predetermined engine speed the clutch is disengaged to prevent stalling or straining of the engine. This eliminates the braking torque of the engine, which is clearly perceived by the driver as a change of the rolling resistance of the vehicle, or even, when moving downhill, as an acceleration of the vehicle. No solution for the problem described can be found in the prior art. The often abrupt change of the rolling resistance is undesirable. for reasons of both comfort and safety.

### SUMMARY OF THE INVENTION

Accordingly, the purpose of the present invention is to indicate a device and a method for preventing an abrupt change of the rolling resistance when a vehicle is coasting and/or stopping.

A drivetrain of a vehicle comprises an internal combustion engine, a transmission, a clutch arranged between the internal combustion engine and the transmission, and at least one wheel. In the case of an automated transmission there is also a transmission control unit. In addition, there is a communications bus to enable communication between the components of the drivetrain. Moreover, at least one brake is also provided, which can be a service brake or a supplementary brake of any type.

According to the invention, from the point when the clutch is disengaged a braking torque that is additional to the braking torque of the drivetrain downstream from the clutch is applied. For example, the braking torque of the drivetrain downstream from the clutch is composed of the drag torques of the transmission, of an axle and/or of one or more brakes. The additional braking torque applied corresponds to the braking torque of the internal combustion engine on the wheel of the drivetrain, at the instant or just before the instant when the engine is decoupled from the drivetrain downstream from the clutch by disengaging the clutch. By applying the additional braking torque to the drivetrain downstream from the clutch, the total braking torque that acts on the wheel both before and after disengaging the clutch is kept the same. The result is to increase both the driving comfort of the vehicle and its safety, since no abrupt change of the vehicle's rolling resistance takes place. Thus, the vehicle can coast or stop in a quiet manner.

A communications bus transmits the instantaneous torque of the internal combustion engine to the transmission control unit many times per second. The torque last determined before the clutch was disengaged is converted by the transmission control unit into a braking torque applied by the internal combustion engine to the wheel. The calculated value is used to enable an exact additional braking torque to be applied to the drivetrain downstream from the clutch.

Furthermore, the additional braking torque is produced by a service brake, a hydrodynamic brake, a hydrostatic brake and/or a transmission brake.

In an advantageous variant of the invention the additional braking torque is removed when the vehicle is at rest, to enable driving to be continued immediately. However, the additional braking torque can be removed gradually in accordance with a predetermined time function, for example a ramp. This gives the driver time to react appropriately to the cessation of the braking torque of the internal combustion engine. However, the additional braking torque is removed at the latest if a driver's wish to accelerate is recognized, for example by virtue of a torque demand from the internal combustion engine.

In a further variant of the invention the additional braking torque is only applied when a driver's wish to stop is recognized. This allows even slow coasting of the vehicle.

### BRIEF DESCRIPTION OF THE DRAWINGS

Other advantages and advantageous features of the invention are the object of the figures below and their description. The figures show:

FIG. 1: A greatly simplified representation of a drivetrain, and

FIG. 2: Flow diagram of the method according to the invention.

### DETAILED DESCRIPTION OF THE PREFERRED EMBODIMENTS

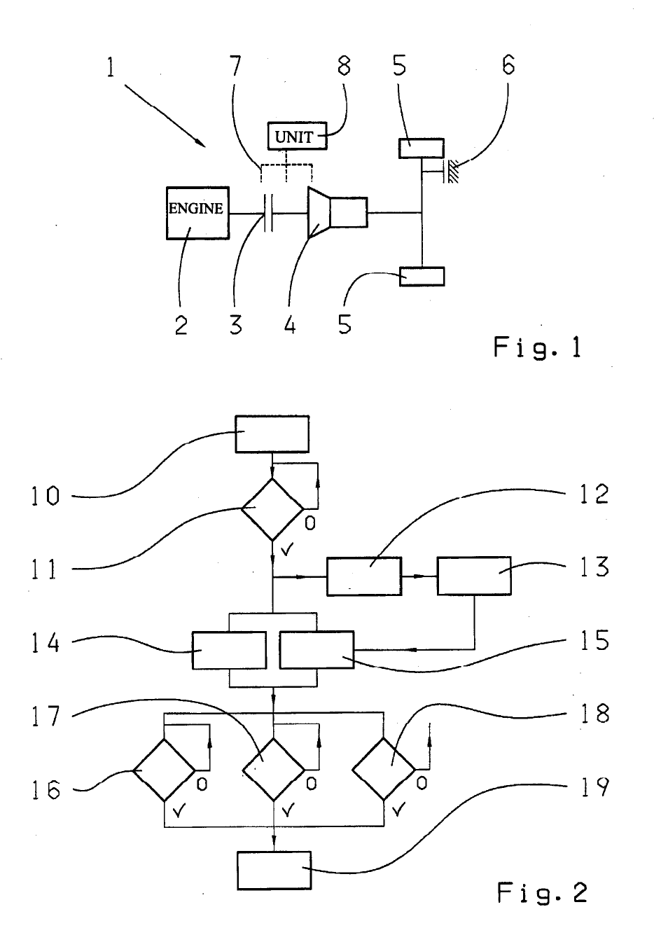

FIG. 1 shows a very simplified representation of a drivetrain 1 comprising a clutch 3 between an internal combustion engine 2 and a transmission 4. The transmission 4 is connected to two drive wheels 5 and a service brake 6 is arranged on the wheels 5. In addition, the drivetrain 1 comprises a transmission control unit 8 and a communications bus 7, the latter connecting the components of the drivetrain 1 to enable communication between them.

FIG. 2 makes clear the sequence of the method. The process begins with coasting of the vehicle in step 10. At some moment the lowest gear of the transmission 4 is engaged and in step 11 the question arises whether the minimum speed of the vehicle has been reached, at which there is a risk of stalling the internal combustion engine 2. If the question in step 11 is answered positively, steps 12, 13, 14 and 15 are triggered in short order. When or shortly before the minimum speed has been reached, the clutch 3 is disengaged in step 14 in order to avoid stalling the internal combustion engine 2. Via the communications bus 6 the torque of the internal combustion engine 2 is communicated to the transmission control unit 8 many times per second, and this is represented as step 12. The torque of the internal combustion engine 2 last determined before the disengaging of the clutch 3 is used by the transmission control unit 8 to calculate the braking torque with which the internal combustion engine 2 acts upon the wheels 4, this calculation being represented by step 13.

At the same time as step 14, i.e. the disengaging of the clutch 3, in step 15 the calculated additional braking torque is applied by the service brake 6 to the drivetrain 1 in such manner that no difference in the rolling resistance of the vehicle can be perceived by the driver. The additional braking torque is remove when one of the following criteria is fulfilled:

step 16: the vehicle is at rest,

step 17: a driver's wish to accelerate is recognized, or

step 18: a time function has lapsed,

and in the case of the time function the additional braking torque is removed in stages.

In FIGS. 1 and 2 a service brake is used to apply the additional braking torque. Other brakes in the drivetrain are not excepted in the context of the invention, so for example a hydrodynamic brake, a hydrostatic brake, or a combination of several different brakes can be used.

### INDEXES

1 Drivetrain
2 Internal combustion engine
3 Clutch
4 Transmission
5 Drive wheels
6 Service brake
7 Communications bus
8 Transmission control unit
10 Coasting
11 Minimum internal combustion engine speed
12 Read in the internal combustion engine speed
13 Calculate the additional braking torque
14 Disengage the clutch
15 Apply the additional braking torque
16 Vehicle is at rest
17 Wish to accelerate
18 Time function lapsed
19 Removal of the additional braking torque
∘ No
√ Yes

1-9. (canceled)

10. A method of controlling a drivetrain (1) of a vehicle, the drivetrain (1) comprising at least an internal combustion engine (2), a transmission (4), a clutch (3) and at least one wheel (5), the clutch (3) being arranged between the transmission (4) and the internal combustion engine (2) and, when the vehicle is coasting, the clutch (3) being disengaged when the internal combustion engine (2) reaches a minimum speed, the method comprising the step of:
from when the clutch (3) is disengaged (14), applying a braking torque additional to a braking torque of the drivetrain downstream from the clutch (3), with the additional braking torque corresponding to the braking torque of the internal combustion engine (2) on the wheel (5) of the drivetrain (1), this application taking place either at a instant or shortly before the instant when the internal combustion engine (2) is decoupled from the drivetrain downstream from the clutch (3) by disengaging (14) the clutch (3).

11. The method according to claim 10, further comprising the step of communicating the braking torque of the internal combustion engine (2), via a communications bus of the drivetrain (1), to a transmission control unit (8) either when or immediately before the clutch (3) is disengaged (14), and
calculating the action of the braking torque on the wheel (5) via the transmission control unit (8).

12. The method according to claim 10, further comprising the step of producing the additional braking torque via at least one of a service brake (6), a hydrodynamic brake, a hydrostatic brake and a transmission brake.

13. The method according to claim 10, further comprising the step of, when the vehicle is at rest, removing the additional braking torque.

14. The method according to claim 13, further comprising the step of removing the additional braking torque upon recognizing a wish to accelerate by a driver.

15. The method according to claim 14, further comprising the step of removing the additional braking torque in accordance with a time function.

16. The method according to claim 15, further comprising the step of only applying the additional braking torque upon recognizing a wish to stop by a driver.

17. A device for controlling a drivetrain (1) of a vehicle, the drivetrain (1) comprising:
at least an internal combustion engine (2),
a transmission (4),
a clutch (3), and
at least one wheel (5),
the clutch (3) being arranged between the transmission (4) and the internal combustion engine (2),
a means (6) for applying an additional braking torque on the drivetrain being located downstream from the clutch (3), and
the additional braking torque corresponding to a braking torque of the internal combustion engine (2) on the wheel (5) of the drivetrain (1) before the disengagement (14) of the clutch.

18. The device according to claim 17, wherein the means (6) for applying the additional braking torque is at least one of a service brake, a hydrodynamic brake, a hydrostatic brake and a transmission brake.

19. A method of controlling a drivetrain (1) of a vehicle, the drivetrain (1) comprises an internal combustion engine (2), a transmission (4), a clutch (3) and wheels (5), the clutch (3) being arranged between the transmission (4) and the internal combustion engine (2) such that the internal combustion engine (2) is disengagable by the clutch when the vehicle is coasting and the internal combustion engine (2) is operating at a minimum speed, the method comprising the steps of:
disengaging the clutch (3);
applying an additional braking torque on the drivetrain (1) downstream from the clutch (3), the additional braking torque corresponding to the braking torque of the internal combustion engine (2) on the wheels (5) of the drivetrain (1), and the additional braking torque being applied on the drivetrain (1) either shortly before simultaneously with the disengagement of the internal combustion engine (2) from the drivetrain (1).
